(19) United States
(12) Patent Application Publication
(10) Pub. No.: US 2025/0027359 A1
(43) Pub. Date: Jan. 23, 2025

(54) COMPOSITE STRUCTURE FOR STATIONARY AND MOBILE FLAT ELEMENTS

(71) Applicant: Keller Minimal Windows S.A., Troisvierges (LU)

(72) Inventor: Werner SCHULZEN, Eupen (BE)

(21) Appl. No.: 18/776,958

(22) Filed: Jul. 18, 2024

(30) Foreign Application Priority Data
Jul. 20, 2023 (LU) 504 779

(51) Int. Cl. E06B 3/86; E06B 3/263; E06B 3/70

(52) U.S. Cl. CPC E06B 3/86; E06B 3/26301; E06B 2003/2637; E06B 2003/7049

(57) ABSTRACT

A composite structure for stationary and mobile flat elements, the structure including a two-dimensional infill, in particular multiple glazing or a composite panel, having first composite profiles each having an outer profile, an inner profile and one or more first separation bars connecting the outer profile and inner profile. The connection between outer profile and inner profile is shear-enabled in the longitudinal direction. The outer profile is mounted against an outer side of the peripheral zone of the infill shear-resistantly relative to the infill in the longitudinal direction in a first length portion of at most 5% of the length of the outer profile, but shear-enabledly over the remaining length. The inner profile is mounted against an inner side of a peripheral zone of the infill shear-resistantly relative to the infill in the longitudinal direction in a second length portion of at least the length of the first length portion.

### CROSS-REFERENCE TO RELATED APPLICATIONS

This application claims the benefit of Luxembourg patent application 504 779, filed on 20 Jul. 2023, the disclosure of which is incorporated herein by reference in its entirety.

### TECHNICAL FIELD

The present disclosure relates in general to a composite structure for stationary and mobile flat elements, such as windows, doors, panels and façade elements, and to the stationary or mobile flat elements obtainable thereby.

### BACKGROUND

Numerous composite profiles and composite profile frame systems are known from the prior art. They preferably consist of metal or a metal alloy and can be exposed to adverse weather conditions and major temperature fluctuations between the inside and outside thereof. Generally problematic from a thermal point of view is a large temperature difference between the outside of the profile frame system, i.e. the side arranged outside the building and the inside of the profile frame system. To prevent thermal bridging, in such composite profile systems two metallic frame profiles (inner and outer profiles) are conventionally connected by one or more thermally less conductive plastics insulating bars, also known as separation bars, in order to achieve thermal separation or decoupling between the inside and the outside.

Since the composite system between the two frame profiles and the separation bars has, of course, simultaneously to fulfil other structural requirements, such as for example tensile or compressive loading, shear, flexure and torsion while at the same time also having to meet aesthetic requirements, the problem of the “bimetallic effect” arises with increasing size and also, as a result of the above-described thermal separation within the composite system, with simultaneous force-locking connection.

The bimetallic effect is a term generally used when two materials with non-identical heat expansion coefficients are joined together and the differing expansion results in deformation. Such difficulties due to repeated major temperature differences mainly arise in flat elements in outer walls, for example in the winter between the room interior and the external air, and in the summer, when insolation leads to an increase in the temperature of the outer profile. This deformation becomes more marked, the greater the temperature difference between inside and outside, the better the thermal separation between inner and outer profiles, the greater the dimensions of the windows, doors and façade elements, the more these are exposed to the sun and the better they absorb sunlight and infrared radiation.

A further aggravating factor is that the infill mounted in these composite profiles is not only itself constructed as a thermally insulating composite, for example as sandwich panels, multiple glazing, etc., and thus also subject to the bimetallic effect, but also it does not have the same structure regarding material, composition etc. It is thus not affected to the same extent by the individual above-stated factors involved in the bimetallic effect as the composite profiles surrounding them.

This results in windows, doors and façade elements becoming distorted, in impairment of tightness functions and, in the case of mobile elements, in difficulties with opening, closing and locking and/or unlocking. The latter may consequently result in the closing elements and/or the frame structures thereof being damaged since the user may force or even have to force opening or closure.

### SUMMARY

The present disclosure provides a composite profile system for windows, doors and façade elements, specifically for mobile elements having large dimensions, which reliably averts the bimetallic effect and thus very largely prevents deformation, distortion and generally the tightness, opening/closing and/or locking malfunctions caused thereby.

This is achieved according to the disclosure by providing a composite structure for stationary and mobile flat elements, such as windows, doors, panels and façade elements, in particular mobile flat elements, the composite structure comprising a two-dimensional infill, in particular multiple glazing or a composite panel, having a plurality of first composite profiles as surround, the first composite profiles each having an outer profile, an inner profile and one or more first separation bars connecting the outer profile and inner profile, the connection between outer profile and inner profile being shear-enabled in the longitudinal direction (e.g. due to shear-enabled or shear-enabledly mounted separation bars, meaning mounted to allow at least a certain degree of shearing between the affixed parts). According to the disclosure, the outer profile is mounted against an outer side of the peripheral zone of the infill shear-resistantly (meaning mounted in order not to allow shearing between the affixed parts) relative to the infill in the longitudinal direction in a first length portion of at most 5% of the length of the outer profile, but shear-enabledly over the remaining length, e.g. the first length portion constitutes between 0.1 and 4%, in particular between 1 and 3% of the length of the outer profile (at room temperature). Although the shear-resistant region may be located at any desired point along the length/longitudinal direction of the outer profile, it is preferably located at one end or in one end region of the outer profile so as to deflect the temperature-related expansion in one direction, wherein the end region extends at most over a distance of at most 10% of the length of the outer profile. In the case of (substantially) vertically installed outer profiles, this is preferably the bottom end or bottom end region. In the case of (substantially) horizontally installed outer profiles, this shear-resistant region may be provided at/in the left-hand or right-hand end/end region. The inner profile is on the other hand, according to the disclosure, mounted against an inner side of a peripheral zone of the infill shear-resistantly relative to the infill in the longitudinal direction in a second length portion of at least the length of the first length portion.

In particular in the case of larger composite structures, the bimetallic effect may lead to considerable curvature of the composite profiles. Shear-enabled connection of the composite profiles by shear-enabled separation bars should theoretically largely deal with this. The inventors have identified, however, that under real-world conditions this is generally only achieved to a limited degree, since these profiles are not used in isolation, but rather as the surround for an infill, which as a rule has a completely different construction, and which usually also constitutes multiple glazing of considerable mass. As a rule, the composite structures also tend to have close-fitting sealing profiles between the infill and the profiles, such that uncontrollable sticking may occur in part, which may result in the shear-enabled separation bars becoming gradually displaced relative to one another due to shear, which may ultimately cause the composite structure as a whole to become permanently distorted.

This may not only result in leaks, but also, in particular in the case of mobile flat elements, have the consequence that it becomes permanently impossible to open, shut or lock them properly. In order to improve the inevitable interplay between the composite profile and the infill, and in this way as far as possible to prevent gradual distortion and also to achieve greater stability of the surround, the inventors have established that it would be advantageous also to contemplate a type of controlledly shear-enabled connection between the surrounding profiles and the infill. Better controlled is intended to mean, on the one hand, that the sealing profiles at best no longer have to fix the infill and the profiles (or vice versa), i.e. they do not have to be so close-fitting, and thus tend less towards sticking and, on the other hand, that distortion of the composite structure surround does not arise even after months or years of repeated expansion and contraction due to sometimes considerable daily temperature fluctuations.

The inventors have recognized that the consequences of the bimetallic effect on (large) flat elements may be successfully counteracted by the solution presented above.

Moreover, specifically in the case of mobile applications, such as in particular in the case of sliding elements, the frequently desired size/height: (and consequently a very heavy infill in the case of multiple glazing) causes the composite profile to be very heavily loaded on the handle side primarily on closing by central pulling. In such cases in particular, but in principle also if desired in the case of stationary flat elements, the shear-resistant second length portion may constitute at least 25%, preferably at least 40% or more than 60% of the length of the inner profile (at room temperature) or indeed the entire length of the inner profile. If the entire length is not shear-enabled throughout, the shear-resistant second length portion is advantageously arranged distributed between a plurality of shear-resistant length sub-portions, but over substantially the entire length of the inner profile. Such extended shear-resistant fitting of the inner profile relative to the infill simultaneously results in even greater stability of the surround, in particular with regard to tensile strength perpendicular to the profile parallel to the plane of the infill.

“Inner/inside” and “outer/outside” should be understood, in the context of the disclosure, to mean that “inner/inside” is the side where the lowest temperature fluctuations are to be expected over the service life, while the term “outer/outside” denotes the opposite side from the surface of the flat element, i.e. the side subject to the greatest differences in temperature.

The infill of the composite structure may be any known type of suitable two-dimensional material, for example a sandwich panel or multiple glazing. In the case of a sandwich panel, the above-mentioned peripheral zone may be outer edge of the infill itself. In the case of multiple glazing, the peripheral zone is preferably an additionally mounted edging, for example in the form of a U profile of suitable plastics material, which is optionally placed onto the peripheral zone of the multiple glazing and preferably stuck in place. Such an edging may be mounted at the time of production of the multiple glazing and in this way additionally protects the glazing from damage during transportation to the installation site.

A shear-resistant connection may be achieved using suitable means and methods, for example by screwing, adhesive bonding, form-locking connection, etc. It is preferably produced by way of one or more shear-resistant brackets, wherein the shear resistance advantageously arises through force- and/or form-locking connection of an appropriately shaped tongue on the shear-resistant bracket in a groove of the peripheral zone of the infill. Shear-resistant fitting by toothing of the appropriately shaped tongue is particularly suitable. If a form-locking connection is (additionally) desired, the peripheral zone of the infill and/or the groove may have corresponding mating toothing.

A shear-enabled or sliding connection is preferably produced by way of one or more shear-enabled brackets spaced in the longitudinal direction of the first composite profile, wherein connection of the shear-enabled bracket to the infill arises for example through a sliding tongue guided in a groove in the peripheral zone of the infill. To improve sliding function, the sliding tongue of the shear-enabled bracket conventionally has a rounded cross-section.

Alternatively or additionally, shear-enabled connection of the outer and inner profiles in the shear-resistant region may also arise at the same time through a shear-resistant block fastened to the two profiles.

The disclosure further relates to a stationary or mobile flat element, such as a window, a door, a panel or a façade element, in particular a mobile flat element, comprising at least one above-described composite structure.

Preferably, such a composite structure is mounted in stationary or mobile manner in or on a composite frame, wherein the composite frame comprises a plurality of second composite profiles, wherein the second composite profiles each have an outer shell, an inner shell and one or more second separation bars connecting the outer shell and inner shell.

The disclosure in particular relates to mobile flat elements such as, for example, a sliding element in a composite frame, wherein the sliding element has multiple glazing as infill and wherein a number of rollers are arranged distributed on the longitudinal side on the bottom of the profile structure in such a way that, in use, sliding of the sliding element proceeds by the rollers being guided on a running rail mounted on the bottom part of the composite frame.

In the context of the disclosure, the first separation bars, the shear-resistant block, and/or the edging preferably consist(s) of a material selected from polyamide; polyolefin, e.g. polypropylene; polyester, e.g. polyethylene terephthalate or polybutylene terephthalate; acrylonitrile-butadiene-styrene; polyvinyl chloride or mixtures or combinations thereof, the material being fibre-reinforced, e.g. glass fibre-reinforced, if necessary or desired.

### BRIEF DESCRIPTION OF THE FIGURES

Certain configurations of the disclosure will now be described below with reference to the attached Figures.

FIG. 1a shows a cross-section through a conventional sliding element structure with fixed frame and sliding element at approximately identical inside and outside temperatures.

FIG. 1b shows a cross-section through the conventional sliding element structure of FIG. 1a with a greater temperature difference between inside and outside.

FIGS. 2a and 2b illustrate, with reference to a cross-section and a longitudinal section of the sliding element, the impact of the bimetallic effect in the situations described in FIGS. 1a and 1b.

FIG. 3 shows a cross-section through an embodiment according to the disclosure with reference to the example of an improved sliding element structure.

FIGS. 4a and 4b illustrate, with reference to a cross-section and a longitudinal section of the embodiment of FIG. 3, neutralisation of the bimetallic effect in accordance with the situations described for conventional sliding elements in FIGS. 2a and 2b.

FIG. 5 shows a portion similar to FIG. 4b, with an additional shear-resistant arrangement of the structure, wherein the cross-section shown on the left, in contrast to FIG. 4b below (Bottom), has been guided through the sliding element.

Further details and advantages of the disclosure may be inferred from the following detailed description of possible embodiments of the disclosure made with reference to the attached figures.

### DETAILED DESCRIPTION OF THE DRAWINGS

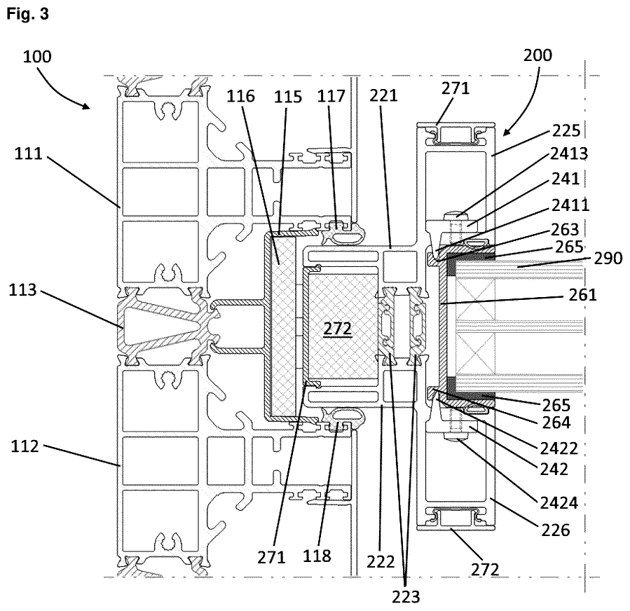

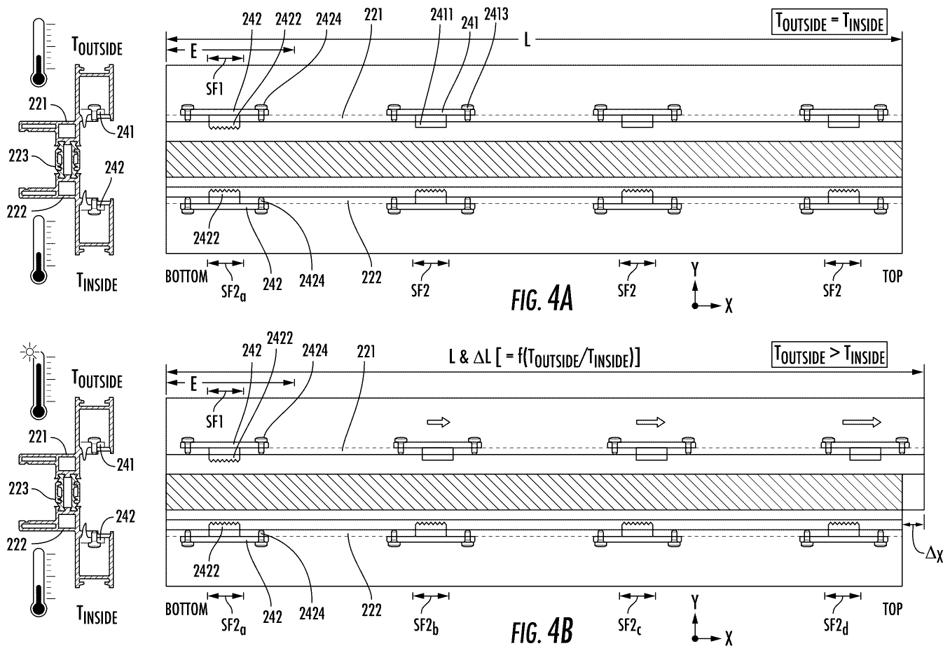

The appended figures explain the above-described problem of the bimetallic effect with reference to the example of a conventional sliding element and an embodiment of a sliding element according to the disclosure. It is, however, once again pointed out that the disclosure is not limited to application to sliding elements. The embodiments shown in FIGS. 3, 4a and 4b and described in greater detail below may equally be used for stationary elements or elements movable in other ways.

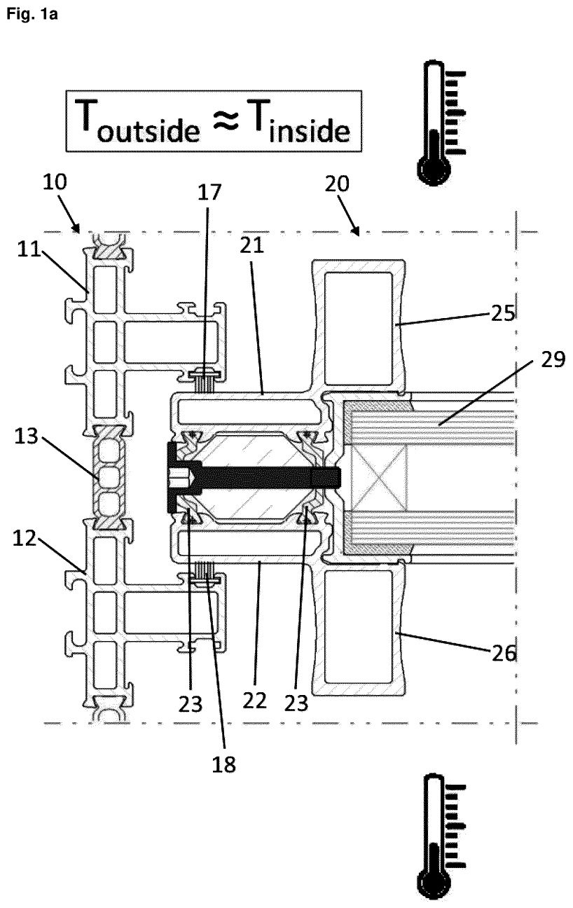

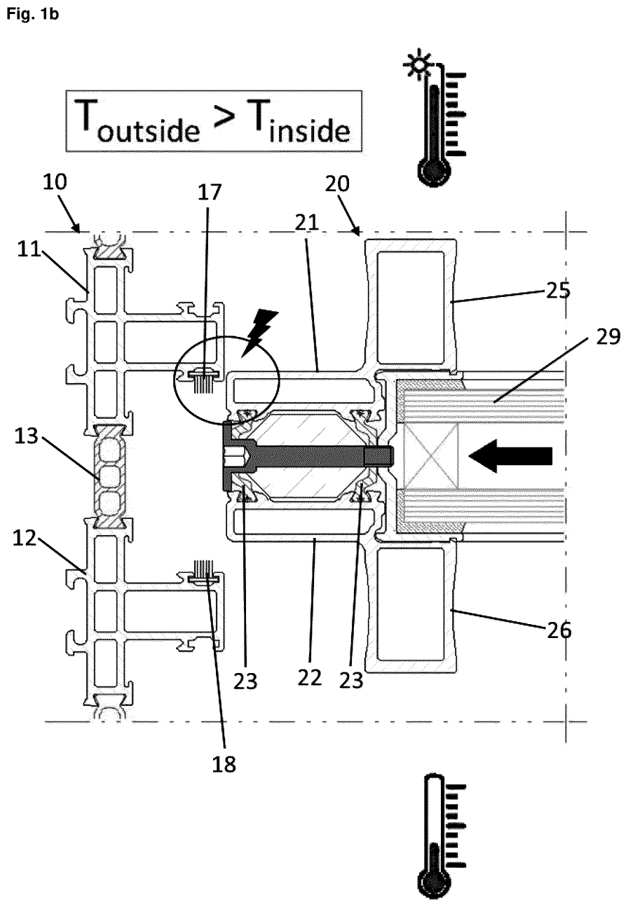

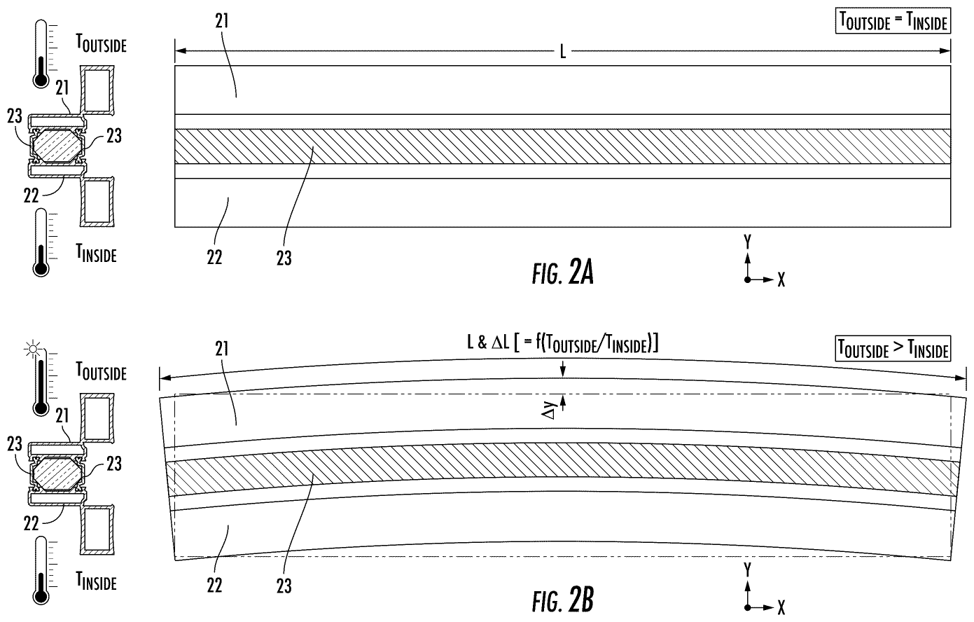

FIGS. 1 and 2 illustrate the bimetallic effect which may occur with conventional sliding elements 20 (background of the disclosure), for example in the case of a glazed sliding door, wherein the problem is amplified by major temperature differences between outside and inside and larger dimensions of the sliding elements 20.

The left-hand side of FIG. 2 shows a cross-section and the right-hand side a longitudinal section through (or plan view onto) a conventional composite profile of a sliding element 20 at approximately identical temperatures inside and out, in this case the vertical composite profile 20 towards the opening side of the sliding element. The composite profile 20 connects an outer profile 21 firmly/force-lockingly together with an inner profile 22 by way of one or more insulating bars 23 configured for thermal separation, wherein the inner and outer profiles 21, 22 conventionally consist of metal, for example aluminium, and the insulating bars 23 are moulded from an optionally (glass) fibre-reinforced plastics material, e.g. polyamide (PA), polyester (PET, PBT), polyolefin (PP), polyvinyl chloride (PVC) or other plastics materials (e.g. ABS, etc.).

When the inner profile 22 (T_{inside}) and the outer profile 21 (T_{outside}) are at approximately identical temperatures along the transverse direction y, each of the profiles 21, 22, and the separation bar 23, have a length L in the longitudinal direction x.

In the case of major temperature differences between the thermally separated outer and inner profiles, i.e. T_{outside}>T_{inside}, for example amplified by severe insolation onto the outer profile, the outer profile 21 expands by an additional length Δx in the longitudinal direction x. As FIG. 2b shows, since the inner profile 22 does not however expand (to the same degree) and all the elements of the composite system are connected rigidly/force-lockingly, the composite profile 20 curves outwards due to the “bimetallic effect”. The degree of curvature Δy in the transverse direction may, however, cause the sliding element to butt laterally against the side part of the profile frame 10, as shown in FIG. 1b. This may lead not only to damage to the composite profile of the sliding element or the frame but may also in some cases prevent the sliding element (sliding door or sliding window) from being properly closed, whether or not the user is aware of this. Such damage may also occur on the opposing side on opening, if the composite profile of the sliding element 20 is able to move at least in part into the opposing frame 10 on full opening. When the sliding element 20 is closed, it is also possible for the bimetallic effect to cause the sliding element 20 to be unopenable or openable only with difficulty, since the curved part becomes jammed in the frame profile 10. This may then also lead to scratches or traces of abrasion on the sliding element 20 and/or on the frame 10.

FIG. 1a consequently shows a conventional closed sliding element 20 (with double glazing as infill 29) in its frame 10 with minor temperature gradients (or no temperature difference) between outer profile 21 and inner profile 22 of the composite profile of the sliding element 20. Both profiles 21, 22 have parts which can serve as handles 25, 26 for operating the sliding element. As already mentioned, the two profiles 21, 22 are connected rigidly/force-lockingly by one or more separation bars 23, for example by curling or shaping a collar, etc. These separation bars 23 enable the heat-insulating function of the composite profile 20 as they act as thermal separation and so greatly reduce heat transfer by conduction from inside to outside, or from outside to inside.

The frame 10 in which the sliding element 20 is able to move is in principle of similar construction to the composite profile, with an outer frame part 11 and an inner frame part 12 which are thermally separated and connected force-lockingly by one or more separation bars 13. To ensure wind- and heat-sealing closure when the sliding element 20 is closed, the frame has a U-shaped cross-section facing the sliding element, in which the outer region of the composite profile of the sliding element 20 is located when closed, wherein the wind- and heat-sealing function may be completed by further auxiliary means 17, 18, such as for example brush, felt or rubber seals.

FIG. 1b, on the other hand, shows the situation in the case of a large temperature difference between the outer and inner profiles 21, 22: T_{outside}>T_{inside}. Elements which are the same as in FIG. 1a are indicated by the same reference signs. Here the cross-section, again for example halfway up the sliding element 20, shows that the outwardly curved part of the sliding element 20 can no longer be readily guided in the U-shaped cross-section of the frame 10 (see highlighted point in FIG. 1b). In other words, the sliding element 20 will butt with its outer profile 21 against the frame and possibly damage it or even prevent full closure of the sliding element 20. Locking (with locking means not shown here) of the sliding element 20 might in this case consequently even be impossible, specifically while the temperature difference between outer and inner profiles 21, 22 lies above a certain value. It might be necessary to wait until this temperature difference has reduced sufficiently, i.e. until Δy has decreased sufficiently, for the outer profile 21 of the sliding element 20 once again to be movable in the U-shaped cross-section of the frame 10. Damage that has already been caused to the frame 10 or to the composite profile of the sliding element 20 cannot, however, be undone thereby.

FIG. 3 is a cross-sectional representation of an embodiment of the disclosure with reference to the example of a sliding element 200 in a frame 100, wherein the cross-section lies for example roughly halfway up the frame 100.

As in the prior art, the fundamental elements of the frame 100 and the sliding element 200 are also present here. The frame (second composite profile) 100 is formed by an outer shell 111 and an inner shell 112, which are connected rigidly/force-lockingly by one or more separation bars 113. Here too, the frame 100 forms a U-shaped cross-section for accommodating the outer edge of the sliding element 200 when closed. As in the prior art, wind- and heat-sealing auxiliary means 117, 118, such as flexible sealing lips, are provided for sealing when closed. From both aesthetic and thermal considerations, the U-shaped cross-section is preferably provided with a plastics trim profile 115 which is connected to the elements of the frame 100 for example by slip-on or clip connectors. This plastics trim profile 115 may additionally serve as a limit stop for the sliding element 200. In such cases, it may be convenient for the side of the plastics trim profile 115 facing the sliding element to be provided with a shock-absorbing lining 116, for example a flexible rubber or foam insert. It may here furthermore be convenient to support the plastics trim profile 115 (resiliently) relative to the separation bar 113 located therebehind.

Here too, the sliding element 200 is for example a glazed sliding door, for example with triple glazing as infill 290. The composite profile of the sliding element 200 also has an outer profile 221 and an inner profile 222 connected by one or more separation bars 213. In contrast to the conventional spacer bars, however, separation bars are provided here which are either firmly connected with just one of the two outer and inner profiles 221, 222 and held on the respective other profile by way of a sliding profile, or, as is apparent by way of example in FIG. 3, are in two (or more) parts, wherein one part is connected rigidly/force-lockingly with one of the two profiles and a second part with the other profile, these two parts being joined together slidingly in the longitudinal direction of the profiles, however. These per se known “shear-enabled” separation bars in principle enable a degree of differential expansion between the outer and inner profiles 221, 222. However, use of such shear-enabled separation bars in the composite profiles of the sliding element frame not only generally reduces the flexural rigidity of the composite profiles but also enables the outer and inner profiles to move differently in the longitudinal direction x in each of the composite profiles, whereby the sliding element frame may be wholly or partly distorted.

To prevent distortion of the sliding element frame, according to the disclosure on the one hand the infill 290 of the sliding element 200, for example triple glazing as shown in FIG. 3, is provided with an edging 261 and on the other hand the inner profile 222 is connected shear-resistantly with the edging 261 over a second length portion SF2 (here by way of example the sum of the four length sub-portions SF2ᵢ, i.e. SF2ₐ+SF2_{b}+SF2_{c}+SF2_{d}) of the length L, while the outer profile 221 is connected shear-resistantly at just one point, the first sub-portion SF1, particularly preferably at one end or end region E of the length L. Over the remaining length L, the outer profile 221 is always connected in shear-enabled manner with the edging 261. In the case of the vertically upright composite profile 200 of FIG. 3, the shear-resistantly positioned first length portion SF1 is preferably at or in the vicinity of the lower end, i.e. in the end region E. As a result, it is ensured that the outer profile 221 may expand slidingly in the longitudinal direction relative to the infill 290, or to the inner profile 222, but in controlled manner in just one direction, namely upwards. If the inside and outdoor temperatures move back into line, the two profiles 221, 222 find themselves back in the same position relative to one another and to the infill 290. Increasing, uncontrolled sliding of the profiles 221, 222 relative to one another and/or to the infill 290 and consequently distortion of the sliding element frame is thus avoided. It should once again be pointed out that the embodiments shown not necessarily true to scale in FIGS. 3, 4a, 4b and 5 are of course merely examples which fall within the scope of protection of the claims. It is thus obvious that for example the number and precise embodiment of the shear-enabled and shear-resistant brackets here merely serve as illustration.

Although not shown in the figures, the same applies in principle to a vertical profile opposite the infill 290, which can consequently also only expand in this direction. It is thereby ensured that the shear stress of the bimetallic effect has an equal impact on both sides of the sliding element and no shearing of the sliding element frame occurs. The horizontal composite profiles at the upper and lower edges of the sliding element may be similarly equipped, wherein the shear-resistant point (end region) on the outer profile is then preferably located towards the opening side.

(Partly) shear-resistant connection of the inner profile 222 with the edging 261 of the infill 290 may be achieved by any known procedure, for example by adhesive bonding, screwing, etc. In this case, the edging 261 is preferably connected, e.g. adhesively bonded, to the infill 290 by suitable bonding agents 265 (in the second length portion or the second length sub-portions). (Partly) shear-enabled connection of the surrounded infill may be achieved by simple guidance within a suitable boundary, but movement transversely of the shear direction has then largely to be prevented in some other way, for example by the surrounded infill being situated within a U-shaped cross-section of the composite profiles. In practice, however, such a “loose” connection would often be inadequate. Preferred shear-enabled connections may in general be connections with a groove and a corresponding tongue. The edging 261 on each side facing the outside and inside preferably has one or more grooves 263, 264 in the longitudinal direction, wherein a shear-resistant bracket 242 or shear-resistant brackets 242 at multiple (regularly spaced) points is/are mounted along the longitudinal direction on the inner profile 222 in the second length portion SF2 or the second length sub-portions SF2ᵢ.

In one preferred embodiment this may be achieved in that the tongue on the side facing the groove 264 is roughened or preferably toothed, i.e. has a toothing 2422, such as serrations, hooks or claws, which may be connected force-lockingly and shear-resistantly in the groove 264 with the material of the edging. Alternatively or additionally, the base and/or the side walls of the groove 264 may have corresponding mating toothing so as (additionally) to enable shear resistance through form-locking connection. The one or more shear-resistant brackets 242 may be fastened by mounting on the inner profile using suitable fastening means 2424, for example by screws.

On the opposing outer side, a shear-resistant connection is provided between the outer profile 221 solely at one point which is limited locally in the longitudinal direction (first length portion SF1), for example to one to a plurality of centimetres. In the case of vertical composite profiles, this point is advantageously at the bottom end. The locally limited, shear-resistant bracket on this side and fastening thereof correspond advantageously to that on the inside. Another locally limited shear-resistant connection, as mentioned above, of the outer profile 221 in the first length portion SF1 with the edging 261 of the infill 290 is of course also possible. However, the cross-section in FIG. 3 (e.g. halfway up the sliding element 200) shows a shear-enabled bracket 241 with a smooth (untoothed) tongue, or “sliding tongue” 2411, which is fastened so as to slide in the longitudinal direction in the groove 263. As on the opposing inner side, the shear-enabled bracket 241 may extend over the entire length of the outer profile 221 not occupied by the locally limited, shear-resistant bracket 242 just described, or a plurality of shear-enabled brackets 241 may be mounted at suitable (regularly spaced) points in the longitudinal direction. The shear-resistant brackets 241, the shear-enabled brackets 242 and the fastening means 2413, 2424 therefor may consist independently of metal, for example steel, aluminium or aluminium alloys, or of (glass) fibre-reinforced plastics material, similar to the materials suitable for separation bars.

FIGS. 4a and 4b illustrate the disclosure presented here in the same situations as shown for the prior art in FIGS. 2a and 2b. On the left-hand side, FIGS. 4a and 4b show an embodiment of a (vertical) composite profile according to the disclosure in cross-section with an outer profile 221 and an inner profile 222 connected by shear-enabled separation bars. The respective right-hand side shows a longitudinal section, wherein in FIG. 4a the temperature of the outer profile 221 is approximately the same as that of the inner profile 222. At the bottom end (Bottom), or in an end region E the two profiles are connected by way of a shear-resistant bracket 242 to the edging (not shown) of the infill. Furthermore, the inner profile 222 has further shear-resistant brackets 242 in the second length sub-portions SF2i at regular intervals over the entire length, while in the case of the outer profile 221 all the other brackets apart from in the end region E are shear-enabled brackets 241. Since the temperature difference between inside and outside is slight (T_{outside}=T_{inside}), the bimetallic effect as shown in FIG. 2a will in any event not arise: the two profiles 221, 222 are of equal length.

However, if this temperature difference increases as illustrated in FIG. 4b, the shear-enabled connection produced by the shear-enabled brackets 241 between the outer profile 221 and the edging (not shown) of the infill prevents the bimetallic effect from occurring. The outer profile 221 is able to expand in the longitudinal direction (Δx) without impairing the composite system: the shear-enabled brackets 241 can move freely relative to the edging in the longitudinal direction with the outer profile 221 irrespective of any expansion of said edging, but in a controlled manner only in the upward direction (Top) (see arrows in FIG. 4b) due to the lower (Bottom) shear-resistant bracket 242 on the outer profile 221. The position of the shear-enabled brackets 241 accordingly changes gradually by a distance which is greater, the greater the temperature difference and the greater the distance from the shear-resistance bracket 242. If, as here, the shear-resistant bracket 242 of the outer profile is situated at the bottom end and consequently the relative movement at the most remote of the shear-enabled brackets approaches the longitudinal expansion Δx arising due to the temperature difference, without the composite system being exposed to curvature, the sliding element 200 can be easily and reliably opened and closed even in the case of major temperature differences between the outer and inner profiles.

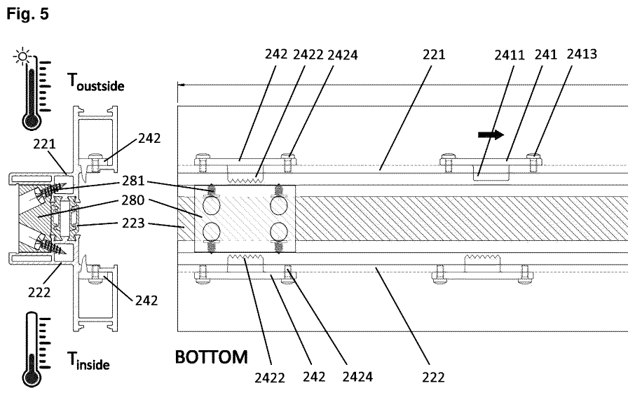

As mentioned, FIG. 5 shows a portion similar to FIG. 4b, with a different/additional shear-resistant arrangement of the structure, wherein the cross-section shown on the left, in contrast to FIG. 4b below (Bottom), has been guided by the sliding element. As an alternative or in addition to the locally shear-enabled fitting of the outer profile 221 with a shear-resistant bracket 242 at the (bottom) end of the composite profile, as explained above, a shear-resistant block 280 may also be provided, which is fixed to both the outer and inner profiles 221, 222, for example using suitable fastening means 281, such as screws, and in this way deflects the expansion of the outer profile 221 reliably in one direction (e.g. upwards) in the event of major temperature differences. This type of local shear-resistant arrangement is more reliably able to absorb the forces arising as a result of differential expansion in the case of larger elements. So as not to have a significant local influence on the thermal insulation of the composite system, this shear-resistant block 280 is preferably made of plastics material, for example like the optionally (glass)fibre-reinforced polymers and polymer blends conventional for separation bars.

1. A composite structure for stationary and mobile flat elements, such as windows, doors, panels and façade elements, the composite structure comprising: a two-dimensional infill, having a plurality of first composite profiles as surround, the first composite profiles each having an outer profile, an inner profile and one or more first separation bars connecting the outer profile and inner profile, the connection between outer profile and inner profile being shear-enabled in the longitudinal direction, wherein
the outer profile is mounted against an outer side of the peripheral zone of the infill shear-resistantly relative to the infill in the longitudinal direction in a first length portion of at most 5% of the length of the outer profile, but shear-enabledly over the remaining length, and
the inner profile is mounted against an inner side of a peripheral zone of the infill shear-resistantly relative to the infill in the longitudinal direction in a second length portion of at least the length of the first length portion.

2. The composite structure according to claim 1, wherein the infill is a sandwich panel and the peripheral zone is the outer edge of the infill itself.

3. The composite structure according to claim 1, wherein the infill is multiple glazing and the peripheral zone is an additionally mounted edging.

4. The composite structure according to claim 1, wherein the shear-resistant second length portion constitutes at least 25% of the length of the inner profile, the shear-resistant second length portion being arranged distributed between a plurality of shear-resistant length sub-portions over substantially the entire length of the inner profile.

5. The composite structure according to claim 1, wherein the shear-resistant connection is arranged in an end region of the length of the inner profile/outer profile, wherein the length of the end region amounts to at most 10% of the length.

6. The composite structure according to claim 1, wherein the shear-resistant connection is produced by way of one or more shear-resistant brackets, wherein the shear resistance arises through force- or form-locking connection of an appropriately shaped tongue on the shear-resistant bracket in a groove of the peripheral zone of the infill.

7. The composite structure according to claim 6, wherein the appropriately shaped tongue of the shear-resistant bracket has toothing.

8. The composite structure according to claim 7, wherein the groove has a corresponding mating toothing.

9. The composite structure according to claim 1, wherein the shear-enabled connection is produced by way of one or more shear-enabled brackets spaced in the longitudinal direction of the first composite profile, wherein the connection of the shear-enabled bracket to the infill arises through a sliding tongue guided in a groove in the peripheral zone of the infill.

10. The composite structure according to claim 9, wherein the sliding tongue of the shear-enabled bracket has a rounded cross-section.

11. The composite structure according to claim 1, wherein the shear-resistant connection of the outer and inner profiles arises through a shear-resistant block within the first length portion, which shear-resistant block is fastened to the two profiles.

12. The composite structure according to claim 1, wherein the first separation bars, the shear-resistant block, or the edging consist(s) of a material selected from the group consisting of: polyamide; polyolefin; polyester; acrylonitrile-butadiene-styrene; polyvinyl chloride or mixtures or combinations thereof, the material being fibre-reinforced.

13. A stationary or mobile flat element comprising at least one composite structure according to claim 1.

14. The stationary or mobile flat element according to claim 13, wherein a composite structure is mounted in stationary or mobile manner in or on a composite frame, wherein the composite frame comprises a plurality of second composite profiles, wherein the second composite profiles each have an outer shell, an inner shell and one or more second separation bars connecting the outer shell and inner shell.

15. The stationary or mobile flat element according to claim 13, wherein the second separation bars consist of a material selected from the group consisting of: polyamide; polyolefin; polyester; acrylonitrile-butadiene-styrene; polyvinyl chloride or mixtures or combinations thereof, the material being fibre-reinforced.

16. The mobile flat element according to claim 13, a sliding element in a composite frame, wherein the sliding element has multiple glazing as infill, wherein a number of rollers are arranged distributed on the longitudinal side on the bottom of the profile structure in such a way that, in use, sliding of the sliding element proceeds by the rollers being guided on a running rail mounted on the bottom part of the composite frame.
